(19) United States
(12) Patent Application Publication
(10) Pub. No.: US 2020/0323301 A1
(43) Pub. Date: Oct. 15, 2020

(54) HEATING DEVICE

(71) Applicants: DENSO CORPORATION, Kariya-city, Aichi-pref. (JP); SOKEN, INC., Nishio-city, Aichi (JP)

(72) Inventors: Jun YAMAOKA, Kariya-city (JP); Koji ITO, Kariya-city (JP); Kenichiro MAEDA, Kariya-city (JP); Takashi SAITOU, Nisshin-city (JP)

(21) Appl. No.: 16/087,163

(22) PCT Filed: Feb. 2, 2017
(86) PCT No.: PCT/JP2017/003784

§ 371 Date: Sep. 21, 2018

(30) Foreign Application Priority Data
Mar. 24, 2016 (JP) 2016-060498

(51) Int. Cl. A43B 3/00; A43B 17/04; A43B 7/02; H05B 6/06; H05B 6/10; H05B 6/44; B60N 2/00; B60N 2/56; B60H 1/00

(52) U.S. Cl. CPC A43B 3/0005; A43B 17/04; A43B 7/02; H05B 6/06; H05B 2203/02; H05B 6/44; B60N 2/002; B60N 2/5685; B60H 1/00828; H05B 6/105

(57) ABSTRACT

A heating device includes an insole member which is disposed in a footwear and which includes a heating member, and an induction heating coil that heats the heating member through electromagnetic induction, the insole member being formed separately from the footwear.

### CROSS REFERENCE TO RELATED APPLICATIONS

This application is based on Japanese Patent Application No. 2016-60498 filed on Mar. 24, 2016, the description of which is hereby incorporated by reference.

### TECHNICAL FIELD

The present disclosure relates to a heating device having an induction heating coil for heating a heating member through electromagnetic induction.

### BACKGROUND ART

Conventionally, for example Patent Document 1 discloses a technique in which a heat insulating member and a heating member for heating the heat insulating member are provided in a ski equipment, and a heating device is used to heat the heating member through electromagnetic induction.

### PRIOR ART DOCUMENTS

### Patent Documents

[Patent Document 1] JP H7-236502 A

### SUMMARY OF INVENTION

In the device disclosed in Patent Document 1, the heat insulating member and the heating member are integrated with the ski equipment, and are therefore limited to being used with the specialized ski equipment leading to a lack of general purpose versatility.

It is an object of the present disclosure provide warming of the feet of a user without specialized footwear.

According to one aspect of the present disclosure, a heating device includes an insole member which is disposed in a footwear and which includes a heating member, an induction heating coil that heats the heating member through electromagnetic induction, where the insole member is formed separately from the footwear.

According to such a configuration, since the insole member having the heating member is formed separately from the footwear, it is possible to warm the feet of a user feet without requiring specialized footwear.

### BRIEF DESCRIPTION OF DRAWINGS

FIG. 1 is a view showing a configuration of a heating device according to a first embodiment, and shows a state in which a shoe of a user is placed on a foot rest surface of an accelerator pedal of a vehicle.

FIG. 2 is an enlarged view of portion A in FIG. 1.

FIG. 3 is a view showing a configuration of an induction heating member.

FIG. 4 is a view showing a configuration of a metal foil.

FIG. 5 is a diagram for explaining the PTC characteristics of a metal foil.

FIG. 6 is a block diagram of a heating device according to a first embodiment.

FIG. 7 is a diagram for explaining the heating of a metal foil by electromagnetic induction.

FIG. 8 is a diagram showing a correlation between an impedance Z of an induction heating coil and a temperature T of a metal foil.

FIG. 9 is a flowchart of a controller according to a first embodiment.

FIG. 10 shows the relationship between contact surface temperature and contact time causing thermal effects on human skin.

FIG. 11 is a diagram showing a configuration of a heating device according to a second embodiment.

FIG. 12 is a view showing a state in which an induction heating member is arranged on a floor mat.

FIG. 13 is a block diagram of a heating device according to a second embodiment.

FIG. 14 is a flowchart of a controller of the heating device according to the second embodiment.

FIG. 15 is a diagram showing a configuration of a heating device according to a third embodiment.

FIG. 16 is a view of a floor mat disposed on the floor surface of a building as viewed from the upper surface side.

FIG. 17 is a view of an insole sheet as viewed from the foot rest surface side.

FIG. 18 is a block diagram of a heating device according to a third embodiment.

FIG. 19 is a flowchart of a controller of the heating device according to the third embodiment.

### DETAILED DESCRIPTION

Hereinafter, embodiments of the present disclosure will be described with reference to the drawings. In the following embodiments, identical or equivalent elements are denoted by the same reference numerals as each other in the figures.

### First Embodiment

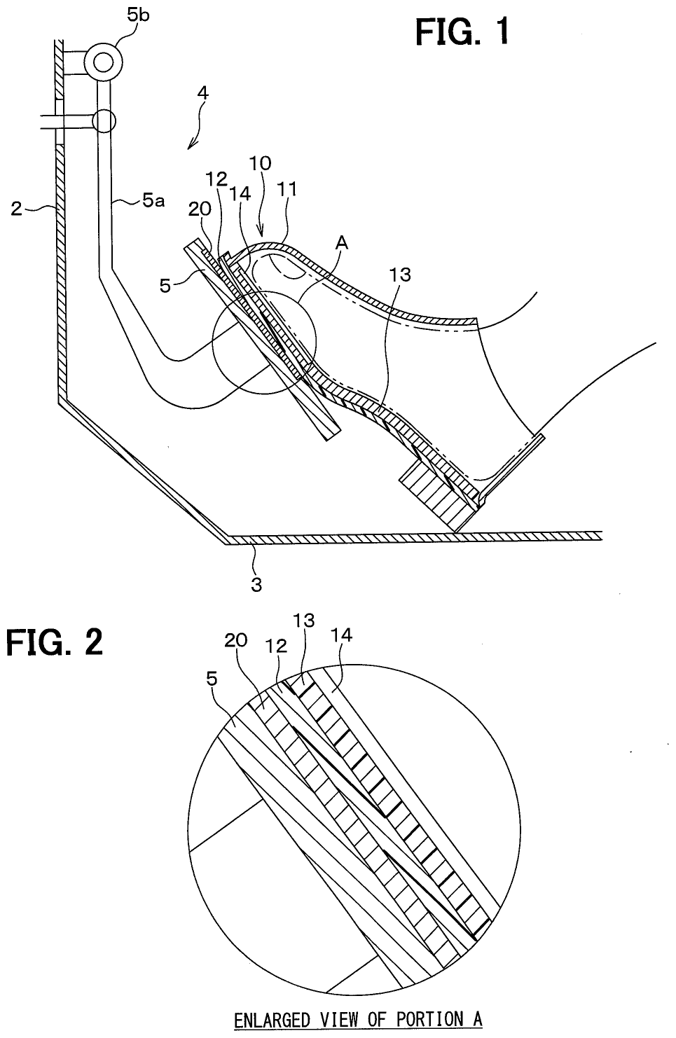

A heating device according to a first embodiment will be described with reference to FIGS. 1 to 9. FIG. 1 is a view showing a state in which a user shoe 10 is placed on a foot resting surface of an accelerator pedal 5 of a vehicle. The arrow DR 1 in FIG. 1 indicates the vehicle front-rear direction. Further, FIG. 2 is an enlarged view of portion A in FIG. 1.

The vehicle is provided with a dash panel 2 that separates an engine room from a passenger compartment and a floor panel 3 that forms the underbody of the vehicle. An accelerator bracket 5b attached to the dash panel 2 rotatably supports an accelerator link lever 5a. The accelerator pedal 5 is fixed to the lower end of the accelerator link lever 5a. Due to the accelerator bracket 5b, the accelerator pedal 5 may be swung, i.e., may be moved in the vehicle front-rear direction.

A metal foil 14 is provided on an insole 13 disposed on a foot rest surface in the user shoe 10. The present heating device includes an induction heating member 20 that heats the metal foil 14 in a noncontact manner through electromagnetic induction. This induction heating member 20 is fixed to the foot rest surface of the accelerator pedal 5 of the vehicle.

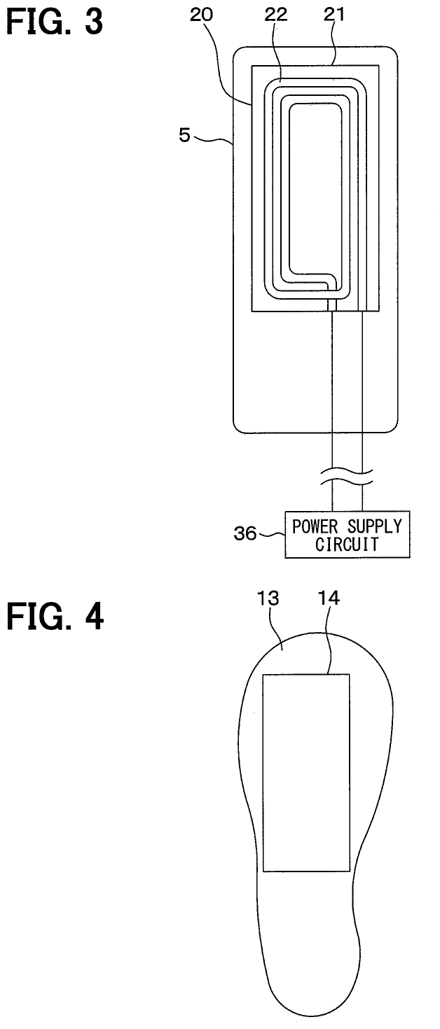

As shown in FIG. 3, the induction heating member 20 includes a thin resin plate 21 which is insulative and an induction heating coil 22 formed on this resin plate 21. The induction heating coil 22 is formed in a coil shape from a conductive metal member (for example, copper).

A power supply circuit 36 that outputs an AC voltage at a predetermined frequency (for example, 25 kHz) is connected to the induction heating coil 22. When the AC voltage at the predetermined frequency is output from the power supply circuit 36, a current corresponding to the AC voltage flows in the induction heating coil 22.

The user shoe 10, as shown in FIG. 1, includes an upper portion 11 wrapped around the foot and a sole 12 that contacts the ground. The upper portion 11 may be made of, for example, leather, synthetic leather, etc., and the sole 12 may be made of, for example, resin, rubber or the like.

The insole 13 is disposed inside the user shoe 10. The insole 13 corresponds to an insole member, and is configured as a separate element from the shoe 10. FIG. 4 is an external view of the insole 13. The metal foil 14, acting as a heating member, is bonded and fixed to the surface of the insole 13 in contact with the sole of the user.

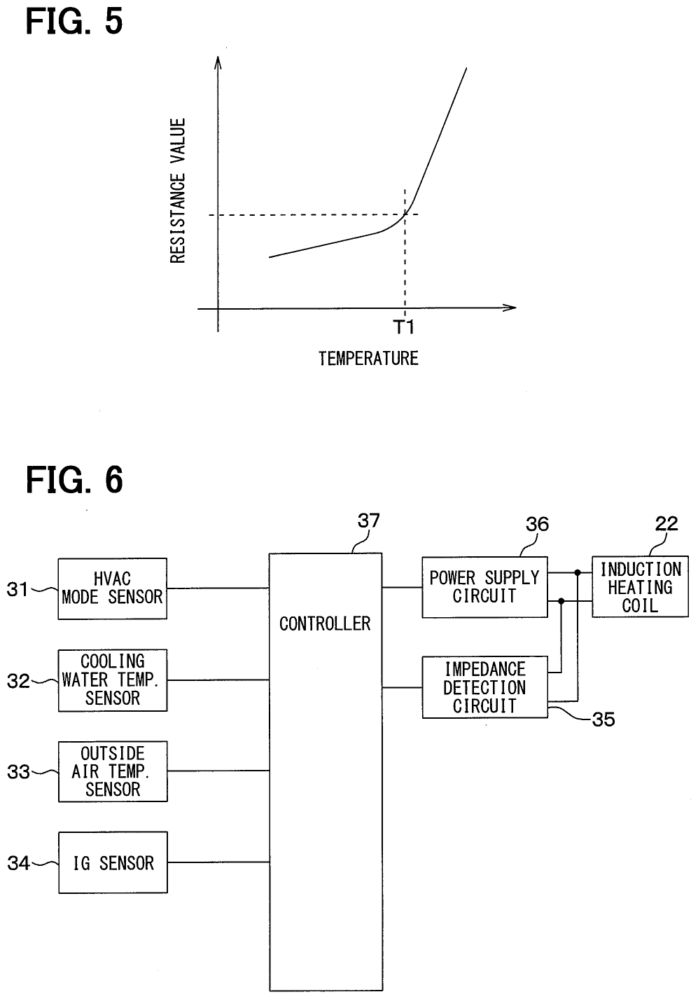

The metal foil 14 is formed of a PTC (Positive Temperature Coefficient) member (resistor) having positive temperature coefficient characteristics, and is shaped as a thin plate. FIG. 5 is a diagram showing the relationship between the temperature and the resistance value of the metal foil 14 of the insole 13. As shown in this figure, the metal foil 14 of the insole 13 has a PTC characteristic in that the resistance value of the metal foil 14 of the insole 13 is low when the temperature is low, and when the temperature rises and reaches a predetermined temperature T1 (that is, the Curie point), the resistance value begins to quickly increase. In the present embodiment, the predetermined temperature T1 is about 42° C.

FIG. 6 is a block configuration diagram of the present heating device. The heating device includes an HVAC (also referred to as an air conditioning unit) mode sensor 31, a cooling water temperature sensor 32, an outside air temperature sensor 33, an ignition (also referred to as IG) sensor 34, an induction heating coil 22, an impedance detection circuit 35, a power supply circuit 36 and a controller 37. The power supply circuit 36 and the controller 37 form a power control unit that controls power supplied to the induction heating coil.

The HVAC mode sensor 31 detects various blowing modes of the vehicle air conditioner. These blowing modes include a face mode, a bilevel mode, a foot mode, a foot defroster mode, a defroster mode, etc. The HVAC mode sensor 31 detects the blowing mode and outputs a signal indicating the detected blowing mode to the controller 37.

The cooling water temperature sensor 32 is a temperature sensor that detects the temperature of the cooling water that cools the engine which is the motive power source of the vehicle. The cooling water temperature sensor 32 detects the temperature of the cooling water and outputs a signal indicating the detected temperature to the controller 37.

The outside air temperature sensor 33 is a temperature sensor that detects the temperature of the air outside the passenger compartment (that is, the outside air temperature). The outside air temperature sensor 33 detects the outside air temperature and outputs a signal indicating the detected outside air temperature to the controller 37.

The ignition sensor 34 is a sensor that detects the ON or OFF state of the ignition switch. The ignition sensor 34 outputs a signal indicating whether the ignition switch is ON or OFF to the controller 37.

The impedance detection circuit 35 is connected in parallel with the induction heating coil 22, and is configure to detect the impedance Z of the induction heating coil 22. The impedance detection circuit 35 outputs a signal indicating the detected impedance Z of the induction heating coil 22 to the controller 37. The impedance detection circuit 35 detects the impedance of the induction heating coil 22 which is correlated with the temperature of the metal foil 14 of the insole 13.

The power supply circuit 36 is an AC signal generation source that generates AC signals at a constant voltage (for example, 48V) and a predetermined frequency (for example, 25 kHz). The induction heating coil 22 is connected to the output terminal of the power supply circuit 36. The power supply circuit 36 operates or stops in accordance with a signal input from the controller 37.

The controller 37 is a computer having a CPU, a ROM, a RAM, I/O, etc., and the CPU performs various arithmetic processing based on programs stored in the ROM to, for example, control the power supply circuit 36. This ROM and RAM are non-transitory tangible storage mediums.

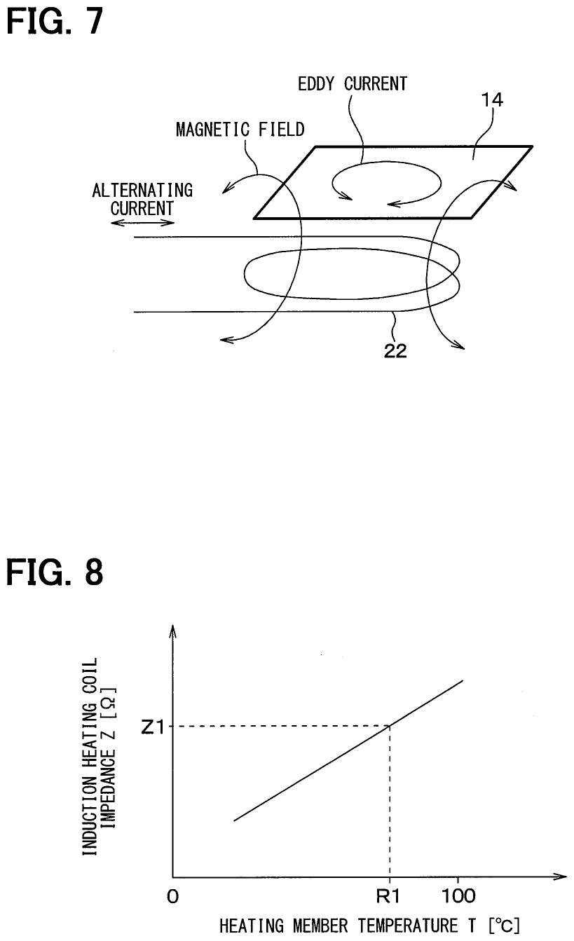

Next, the heating of the metal foil 14 of the insole 13 by electromagnetic induction will be described with reference to FIG. 7. Here, it is assumed that the metal foil 14 is in a low temperature state. When an AC voltage is output from the power supply circuit 36 and an AC current flows through the induction heating coil 22, the magnetic field around the induction heating coil 22 changes. As a result, an eddy current that cancels out this magnetic field is generated in the metal foil 14 which is disposed in the vicinity of the induction heating coil 22. Further, assuming the electrical resistance of the metal foil 14 is R and the eddy current in the metal foil 14 is I, a Joule heat of R×I² is generated in the metal foil 14.

In addition, the metal foil 14 of the insole 13 in the present embodiment is formed from a positive temperature characteristic member which is a resistance pair having a PTC characteristic as described above. Accordingly, when the temperature of the metal foil 14 gradually increases, the resistance value of the metal foil 14 also gradually increases, and as a result it becomes more difficult for the eddy current to flow through the metal foil 14. As such, the rate at which the temperature of the metal foil 14 increases gradually decreases.

When the temperature of the metal foil 14 reaches the predetermined temperature T1 (that is, the Curie point), the resistance value of the metal foil 14 begins to rapidly increase. As a result, eddy currents mostly stop flowing in the metal foil 14, and the amount of energy provided to the metal foil 14 also decreases. Accordingly, the impedance of the induction heating coil 22 increases.

Thus, there is a correlation between the temperature T of the metal foil 14 and the impedance Z of the induction heating coil 22. FIG. 8 shows the relationship between the temperature T of the metal foil 14 and the impedance Z of the induction heating coil 22. As shown in this figure, as the temperature T of the metal foil 14 rises, the impedance Z of the induction heating coil 22 also increases.

In addition, the metal foil 14 of the present embodiment has PTC characteristics. Accordingly, when the temperature rises and reaches the predetermined temperature T1 (that is, the Curie point), the impedance Z of the induction heating coil 22 also begins to change significantly, and so the power transmission control of the induction heating coil 22 may be performed with high accuracy.

The present heating device performs a power transmission control in which power is transmitted to the induction heating coil 22 when the impedance Z of the induction heating coil 22 is less than a reference value Z1, and power transmission to the induction heating coil 22 is stopped when the impedance Z of the induction heating coil 22 is equal to or greater than the reference value Z1.

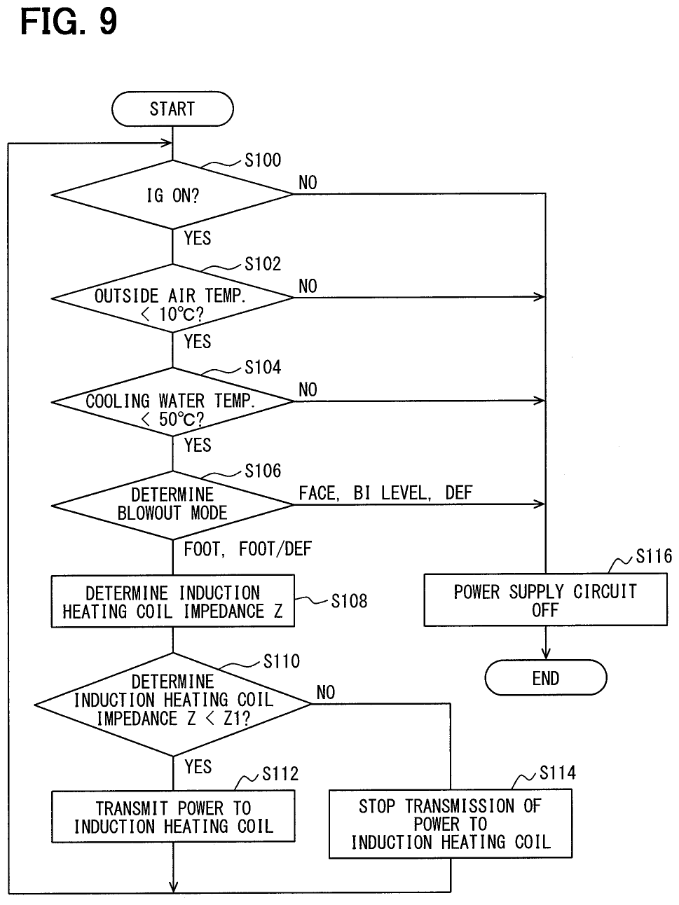

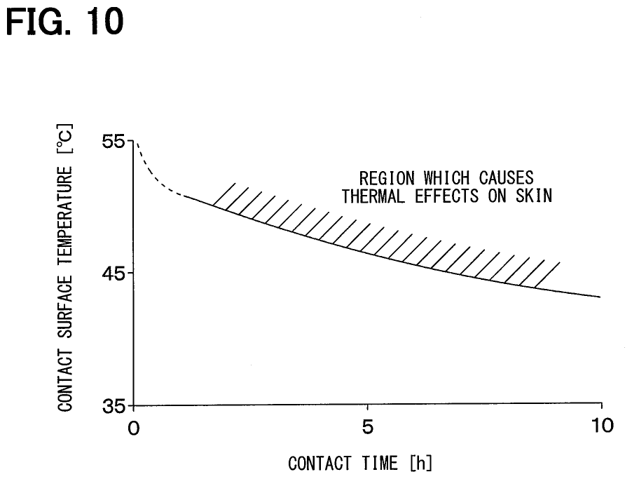

FIG. 9 shows a flowchart of this power transmission control. The controller 37 of the present heating device periodically performs the process shown in this figure. Further, each control step in the flowcharts of the respective drawings includes various function implementation units which are included in the controller 37.

First, in step S100, the controller 37 determines whether or not the ignition switch of the vehicle has been switched from OFF to ON. Specifically, based on the signal input from the ignition sensor 34, it is determined whether or not the ignition switch has been switched from OFF to ON.

When the ignition switch is turned ON from the OFF state by user operation, the determination in step S100 is YES. Next, in step S102, the controller 37 determines whether the outside air temperature is less than a reference value (for example, 10° C.). Here, the outside air temperature can be determined based on a signal input from the outside air temperature sensor 33.

If the outside air temperature is less than the reference value, the determination in step S102 is YES. Next, in step S104, the controller 37 determines whether the temperature of the cooling water that cools the engine is lower than a reference value (for example, 50° C.). Here, the temperature of the cooling water can be determined based on the signal output from the cooling water temperature sensor 32.

When the temperature of the cooling water is less than the reference value, the determination in step S104 is YES, and the controller 37 next determines the blowing mode in step S106. Specifically, based on the signal output from the HVAC mode sensor 31, it is determined whether the blowing mode is set to either one of the foot mode or the foot defroster mode. Here, the foot mode and the foot defroster mode are blowing modes set in winter etc.

When the blowing mode is set to either the foot mode or the foot defroster mode, the controller 37 determines the impedance Z of the induction heating coil 22 in step S108. The impedance Z of the induction heating coil 22 can be determined based on the signal detected by the impedance detection circuit 35. Since the energization of the induction heating coil 22 is not yet started at this time, the controller 37 treats the impedance Z of the induction heating coil 22 as 0.

Next, in step S110, the controller 37 determines whether or not the impedance Z of the induction heating coil 22 is less than the reference value Z1. Here, the reference value Z1 is a value corresponding to when the temperature of the metal foil 14 is at a predetermined temperature R1. The predetermined temperature R1 is set to be higher than typical human body temperature (for example, 36° C.) by a certain number of degrees (for example, 3° C. to 6° C.).

FIG. 10 shows the relationship between contact surface temperature and contact time causing thermal effects on human skin. It is understood that if the contact time is long, even if the contact surface temperature is relatively low, it will cause thermal effects on human skin. Considering these points, the reference value Z1 is determined so as not to cause thermal effects on human skin even when contact time with the heating element is long.

Here, since the impedance Z of the induction heating coil 22 is regarded as 0, the determination in step S110 is YES, and the controller 37 performs power transmission to the induction heating coil 22 in step S112. Specifically, the power supply circuit 36 is instructed to operate, and the power supply circuit 36 outputs an AC signal at a predetermined frequency. That is, predetermined power is supplied from the power supply circuit 36 to the induction heating coil 22.

As a result, a high-frequency alternating current flows through the induction heating coil 22, and the electric field around the induction heating coil 22 changes. Thus, eddy currents are generated in the metal foil 14 which is disposed in the vicinity of the induction heating coil 22, so as to generate a magnetic field that cancels the changes in the magnetic field. Joule heat is generated in the metal foil 14 by the generation of the eddy currents, the metal foil 14 is heated, and the temperature of the metal foil 14 gradually increases.

Since the heat generated by the metal foil 14 is directly transmitted to the foot of the occupant wearing the shoe 10 by heat conduction, the occupant can quickly feel warmth even with a small amount of electric power consumption.

Further, when the temperature of the metal foil 14 increases and reaches the predetermined temperature T1 (that is, the Curie point), the resistance value of the metal foil 14 begins to rapidly increase. As a result, eddy currents mostly stop flowing in the metal foil 14.

Then, when the impedance of the induction heating coil 22 becomes equal to or greater than the reference value Z1, the determination in step S110 is NO, and the controller 37 stops power transmission to the induction heating coil 22 in step S114. As a result, heating of the metal foil 14 by electromagnetic induction is stopped.

In this regard, when the temperature of the metal foil 14 rises, the heating of the metal foil 14 by electromagnetic induction is stopped, thereby reducing the possibility of the occupant feeling an unpleasant thermal sensation.

While power is being transmitted to the induction heating coil 22, if the ignition switch is turned off in response to the operation of the passenger, the determination in step S100 is NO and the controller 37 stops the output of the power supply circuit 36 in step S116.

Further, while power is being transmitted to the induction heating coil 22, if the outside air temperature becomes equal to or higher than the reference value (for example, 10° C.), the determination in step S102 is NO and the controller 37 stops the output of the power supply circuit 36 in step S116.

In this regard, when the ambient temperature is higher than the reference value because the air temperature is high, no AC voltage is output from the power supply circuit 36, and the heating of the metal foil 14 by electromagnetic induction is stopped.

While power is being transmitted to the induction heating coil 22, if the temperature of the cooling water for cooling the engine, which is the motive power source of the vehicle, reaches or exceeds the reference value (for example, 50° C.), the determination in step S104 is NO. As a result, the controller 37 stops the output of the power supply circuit 36 in step S116.

In this regard, when the temperature of the cooling water for cooling the engine becomes equal to or higher than the reference value, the air warmed by the vehicle air conditioner is blown out into the passenger compartment of the vehicle, so that it is not necessary to heat the metal foil 14, and therefore heating of the metal foil 14 by electromagnetic induction is stopped.

While power is being transmitted to the induction heating coil 22, if the blowing mode is changed to one of the face mode, the bilevel mode, or the defroster mode, the determination in step S106 is NO. As a result, the controller 37 stops the output of the power supply circuit 36 in step S116.

According to the above configuration, the heating device includes an insole 13 which is disposed on the shoe 10 and which includes the metal foil 14, and an induction heating coil 22 for heating the insole 13 by electromagnetic induction. Since the insole 13 is formed separately from the shoe 10, it is possible to warm the feet of the user without requiring specialized footwear.

Further, the heating device includes the impedance detection circuit 35 for detecting the impedance of the induction heating coil which is correlated with the temperature of the metal foil 14. The heating device also includes the power supply circuit 36 and the controller 37 which together control power supplied to the induction heating coil 22 based on the impedance of the induction heating coil detected by the impedance detection circuit 35.

According to this, the power supplied to the induction heating coil is controlled based on the impedance of the induction heating coil which is correlated with the temperature of the metal foil 14. Therefore, as compared with the device described in the above-mentioned Patent Document 1, the heating control of the heating member can be performed more accurately.

In addition, the metal foil 14 is made of a PTC characteristic material whose resistance value increases as temperature increases. Accordingly, when the temperature rises and reaches the predetermined temperature T1 (that is, the Curie point), the impedance Z of the induction heating coil 22 also begins to change significantly. As a result, power transmission control of the induction heating coil 22 can be performed with high accuracy.

In the present embodiment, when YES is determined in each of steps S100, S102, S104, and S106, the processes in steps S108 to S114 are performed. Alternatively, the controller 37 may perform the processing of steps S108 to S114 by omitting at least one of steps S100, S102, S104, and S106 as long as YES is determined in the remaining steps.

For example, in step S100, when the ignition switch of the vehicle turns from OFF to ON, the controller 37 may proceed to step S108 instead. In this case, when the impedance Z of the induction heating coil 22 is less than the reference value Z1 in step S110, the controller 37 supplies a predetermined amount of electric power to the induction heating coil 22.

In a situation where the ignition switch of the vehicle is OFF, there is a high possibility that the temperature inside the vehicle is low. In the present embodiment, when it is determined that the ignition switch of the vehicle is turned from OFF to ON, a predetermined amount of electric power is supplied to the induction heating coil 22 so that the heating member can be quickly heated as soon as the passenger enters the vehicle.

In addition, when the ignition switch is turned OFF, no AC voltage is output from the power supply circuit 36, and power supply to the induction heating coil 22 is stopped, so that it is possible to prevent the vehicle from running out of battery power.

Further, for example, if it is determined in step S102 that the outside air temperature detected by the outside air temperature sensor 33 is equal to or lower than the reference outside air temperature, the controller 37 may proceed to step S108. In this case, when the impedance Z of the induction heating coil 22 is less than the reference value Z1 in step S110, the controller 37 supplies a predetermined amount of electric power to the induction heating coil 22.

When the outside air temperature is equal to or lower than the reference outside air temperature, a predetermined amount of electric power is supplied to the induction heating coil 22, so that the heating member can be quickly heated. In addition, when the outside air temperature becomes equal to or higher than the reference outside air temperature, the power supply to the induction heating coil 22 is stopped, so that the heating member is not heated more than necessary.

Further, if it is determined in step S104 that the temperature of the engine cooling water of the vehicle detected by the cooling water temperature sensor 32 is equal to or lower than the reference water temperature, the controller 37 may proceed to step S108. In this case, when the impedance Z of the induction heating coil 22 is less than the reference value Z1 in step S110, a predetermined amount of electric power is supplied to the induction heating coil 22.

When the temperature of the engine cooling water of the vehicle is low, hot air is not blown out from the foot air outlet of the air conditioner for the vehicle, but when the temperature of the engine cooling water of the vehicle is lower than the reference water temperature, a predetermined amount of electric power is supplied to the induction heating coil 22, so that the heating member can be quickly heated. Further, when the temperature of the engine cooling water of the vehicle becomes equal to or higher than the reference water temperature, the power supply to the induction heating coil 22 is stopped, so that the heating member is not heated more than necessary.

In addition, if it is determined in step S106 that the blowing mode is set to either the foot mode or the foot defroster mode, the controller 37 may proceed to step S108. In this case, when the impedance Z of the induction heating coil 22 is less than the reference value Z1 in step S110, the controller 37 supplies a predetermined amount of electric power to the induction heating coil 22.

The foot mode and the foot defroster mode are typically blowing modes set during heating. In this regard, when the foot mode or the foot defroster mode is set as the blowing mode, a predetermined amount of electric power is supplied to the induction heating coil 22, so that the heating member can be quickly heated. Further, when a blowing mode other than the foot mode or the foot defroster mode is set, the power supply to the induction heating coil 22 is stopped, so that the heating member is not heated more than necessary.

### Second Embodiment

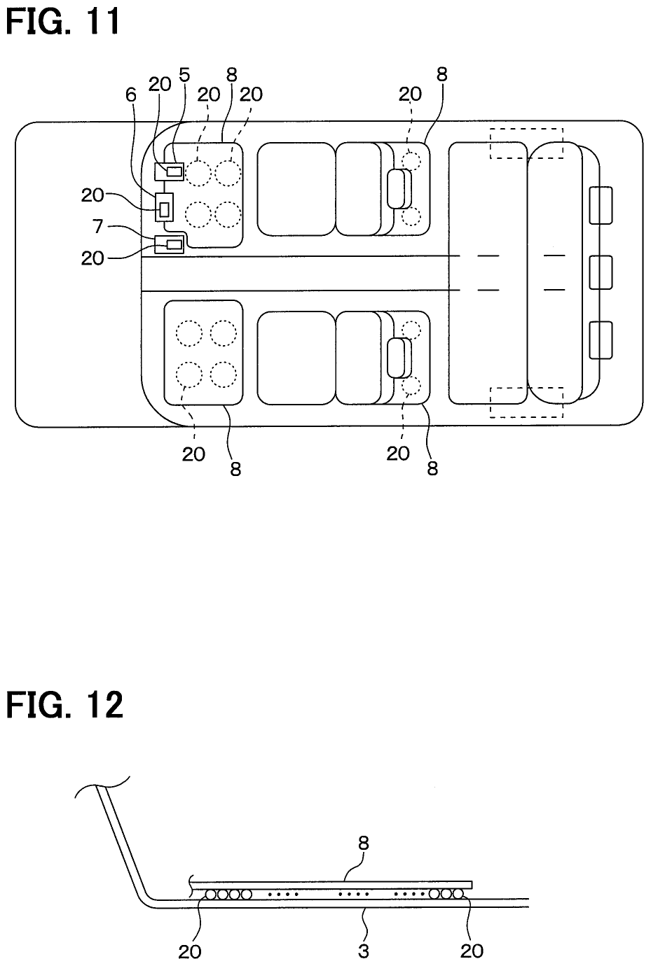

The overall configuration of the heating device according to the second embodiment is shown in FIG. 11. FIG. 11 is a diagram of a vehicle equipped with the present heating device as seen from above the vehicle. In the heating device of the first embodiment, the induction heating member 20 is provided on the foot rest surface of the accelerator pedal 5 of the vehicle. In contrast, in the present embodiment, in addition to the foot rest surface of the accelerator pedal 5 of the vehicle, the induction heating member 20 and the impedance detection circuit 35 are also provided on the foot rest surface of the brake pedal 6 of the vehicle and the foot rest surface of the footrest 7. Further, the induction heating member 20 and the impedance detection circuit 35 are also provided in each of the four floor mats 8 corresponding to the driver seat, the passenger seat, the driver seat side rear seat, and the passenger seat side rear seat.

FIG. 12 is a side view of a floor mat 8. As shown in the drawing, the induction heating member 20 provided in the floor mat 8 is provided on the rear side of the floor mat 8, that is, on the side of the floor mat 8 which is in contact with the floor panel 3.

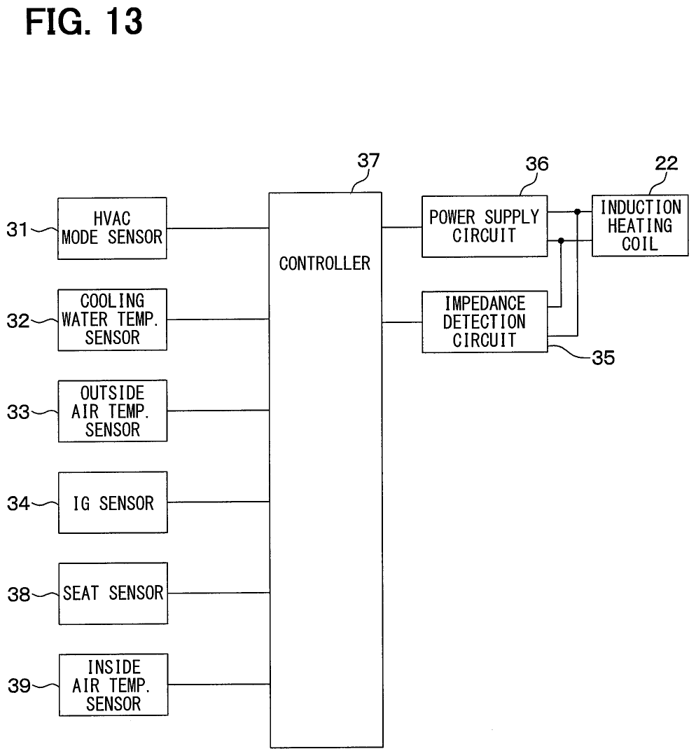

Next, the heating device of the present embodiment will be described with reference to the block diagram of FIG. 13. The configuration of the present heating device is different from that of the first embodiment in that a seat sensor 38 and an inside air temperature sensor 39 are further provided.

The seat sensor 38 is provided in the driver seat, the passenger seat, the driver seat side rear seat, and the passenger seat side rear seat. The seat sensor 38 detects the presence or absence of an occupant in the seat of the vehicle and outputs a signal indicating presence or absence of a passenger in the seat to the controller 37.

The inside air temperature sensor 39 is a temperature sensor that detects the temperature of the air inside the passenger compartment (that is, inside air temperature). The inside air temperature sensor 39 detects the inside air temperature and outputs a signal indicating the detected inside air temperature to the controller 37.

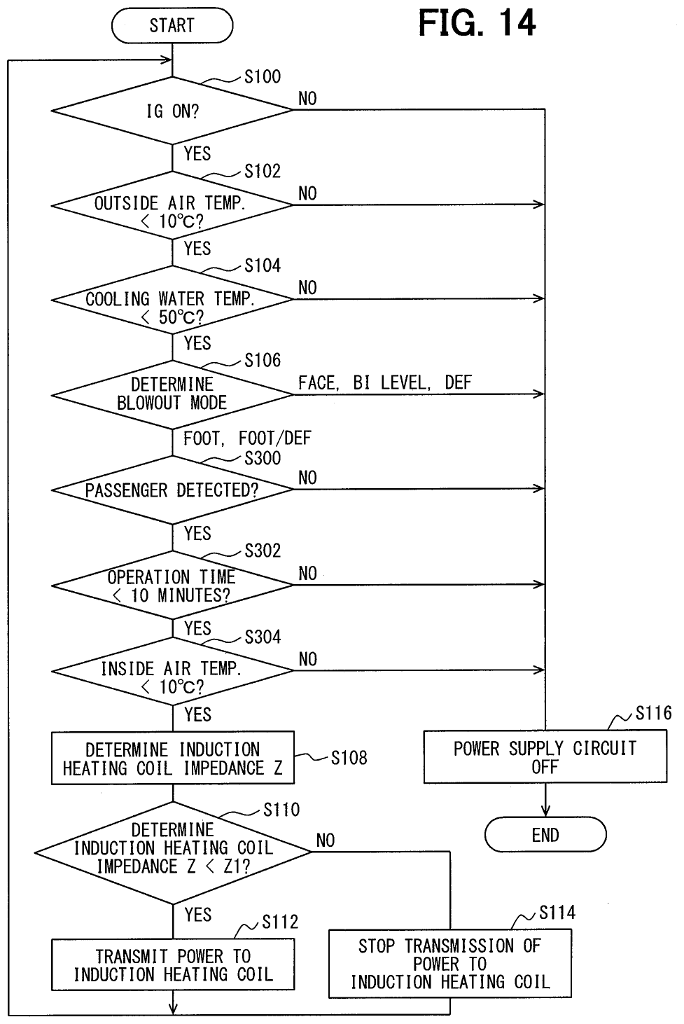

FIG. 14 shows a flowchart of power transmission control by the controller 37 according to the second embodiment. Compared with the flowchart of the first embodiment, the flowchart shown in this figure performs the determination steps of steps S300, S302, and S304 between step S106 and step S108.

Since steps S100 to S106 are the same as the flowchart of FIG. 9, the description thereof is omitted here.

Here, if it is determined in step S106 that one of the foot mode or the foot defroster mode is selected, then in step S300, the controller 37 determines whether or not an occupant has been detected in each seat of the vehicle. Specifically, based on a signal output from the seat sensor 38, it is determined whether or not an occupant is present in each seat of the vehicle.

When it is detected that an occupant is present in the seat of the vehicle based on the signal output from the seat sensor 38, the determination in step S300 is YES. In this case, in step S302, the controller 37 determines whether an operation time, which is the amount of time elapsed since an operation started, is less than a predetermined time (for example, 10 minutes). Specifically, the controller 37 measures the time from the start of power transmission to the induction heating coil 22, and determines whether or not the amount of time elapsed from the start of power transmission to the induction heating coil 22 is shorter than a predetermined time.

When the operation time, which is the amount of time elapsed after the start of the operation, is less than the predetermined time, the determination of S302 is YES and the controller 37 next determines whether the inside air temperature has reached a predetermined value (for example, 10° C.) or not. Specifically, it is determined whether the inside air temperature detected by the inside air temperature sensor 39 is less than a predetermined value.

When the inside air temperature detected by the inside air temperature sensor 39 is less than the predetermined value, the determination in step S304 is YES, and the controller 37 proceeds to step S108. Therefore, when the impedance Z of the induction heating coil 22 is less than the reference value Z1, energization of the induction heating coil 22 is started.

In the present embodiment, a predetermined amount of electric power is supplied to the induction heating coils 22 provided corresponding to the positions of the seats where the occupant is present, and electric power is not supplied to the induction heating coils 22 provided corresponding to the positions of the seats where no occupant is present. Further, when the impedance Z of the induction heating coil 22 is equal to or larger than the reference value Z1, the energization to the induction heating coil 22 is stopped.

While power is being transmitted to the induction heating coils 22, if all the passengers exit the vehicle and occupants are no longer present in the seats of the vehicle, the determination in step S300 is NO. In this case, the controller 37 stops the output of the power supply circuit 36 in step S116.

In this regard, when occupants are absent from the seats of the vehicle, no AC voltage is output from the power supply circuit 36, and the heating of the metal foil 14 by the electromagnetic induction is stopped, so that it is possible to prevent the vehicle from running out of battery power.

While power is being transmitted to the induction heating coils 22, if the operation time, which is the amount of time elapsed after the start of operation, reaches the predetermined time, the determination in S302 becomes NO. In this case, the controller 37 stops the output of the power supply circuit 36 in step S116.

In this regard, if the operation time, which is the amount of time elapsed after the start of operation, reaches the predetermined time, no AC voltage is output from the power supply circuit 36, and the heating of the metal foil 14 by the electromagnetic induction is stopped, so that it is possible to reduce power consumption.

While power is being transmitted to the induction heating coils 22, if the inside air temperature becomes equal to or higher than the predetermined value (for example, 10° C.), the determination in S304 becomes NO. In this case, the controller 37 stops the output of the power supply circuit 36 in step S116.

In this regard, if the inside air temperature is equal to or greater than the predetermined value, no AC voltage is output from the power supply circuit 36, and the heating of the metal foil 14 by the electromagnetic induction is stopped, so that it is possible to reduce power consumption.

Effects produced by configurations similar to those of the first embodiment described above can be produced in the present embodiment in the same manner as in the first embodiment.

Further, as described above, the heating device includes a plurality of induction heating coils 22 and impedance detection circuits 35. The power supply circuit 36 and the controller 37 control power supplied to the plurality of induction heating coils 22. In this regard, it is possible to control the electric power supplied to the plurality of induction heating coils 22 with one controller 37.

In addition, when a predetermined time has elapsed since starting the power supply to the induction heating coil 22, the controller 37 reduces the power supplied to the induction heating coil 22, so that the power consumption can be reduced.

In addition, the heating device includes a seat sensor 38 that detects the presence or absence of passenger on the seats of the vehicle. The induction heating coils 22 are provided at a plurality of positions corresponding to the positions of the seats. When it is detected by the seat sensor 38 that there is at least one passenger in the seats of the vehicle, the power supply circuit 36 and the controller 37 supply a fixed amount of electric power to the induction heating coil 22 provided at the position corresponding to the seat in which the occupant is present. When it is detected by the seat sensor 38 that there is at least one passenger in the seats of the vehicle, the power supply circuit 36 and the controller 37 reduce the supply of electric power to the induction heating coils 22 provided at the positions corresponding to the seats in which an occupant is not present. Therefore, unnecessary power consumption can be avoided.

In the present embodiment, when the controller 37 determines YES in each of steps S100, S102, S104, S106, S300, S302, and S304, the processes in steps S108 to S114 are performed. Alternatively, the controller 37 may perform the processing of steps S108 to S114 by omitting the determinations at at least one of steps S100, S102, S104, S106, S300, S302, and S304 as long as YES is determined in the remaining steps.

For example, if it is determined in step S300 that an occupant is present in the seats of the vehicle, the controller 37 may proceed to step S108. In this case, when the impedance Z of the induction heating coil 22 is less than the reference value Z1 in step S110, the controller 37 supplies a predetermined amount of electric power to the induction heating coil 22.

Further, the induction heating coils 22 are provided at a plurality of positions corresponding to the positions of the seats. When the seat sensor 38 detects that an occupant is present, the controller 37 supplies a predetermined amount of electric power to the induction heating coils 22 provided corresponding to the positions of the seats where occupants are present, and stops the supply of electric power to the induction heating coils 22 provided corresponding to the positions of the seats where no occupant is present. Therefore, unnecessary power consumption can be avoided.

In addition, if it is determined in S302 that the predetermined time has elapsed since starting the power supply to the induction heating coil 22, the controller 37 may proceed to S108. In this case, when the impedance Z of the induction heating coil 22 is less than the reference value Z1 in step S110, the controller 37 stops the supply of electric power to the induction heating coil.

It is considered that if the heating member is heated for a long time after starting the power supply to the induction heating coil 22, this may cause discomfort to the occupant. In this regard, after starting the power supply to the induction heating coil 22, once a certain period of time elapses, the power supply to the induction heating coil is stopped, and so it is possible to prevent the occupant from feeling uncomfortable.

Further, if it is determined in S304 that the inside air temperature detected by the inside air temperature sensor 39 is less than the predetermined value, the process may proceed to S108. In this case, when the impedance Z of the induction heating coil 22 is less than the reference value Z1 in S110, power supply to the induction heating coil 22 is stopped.

When the inside air temperature is equal to or lower than the reference inside air temperature, a predetermined amount of electric power is supplied to the induction heating coil 22, so that the heating member can be quickly heated. Further, when the inside air temperature is equal to or higher than the reference inside air temperature, power supply to the induction heating coil 22 is stopped, so that it is possible to prevent the heating member from being heated more than necessary.

### Third Embodiment

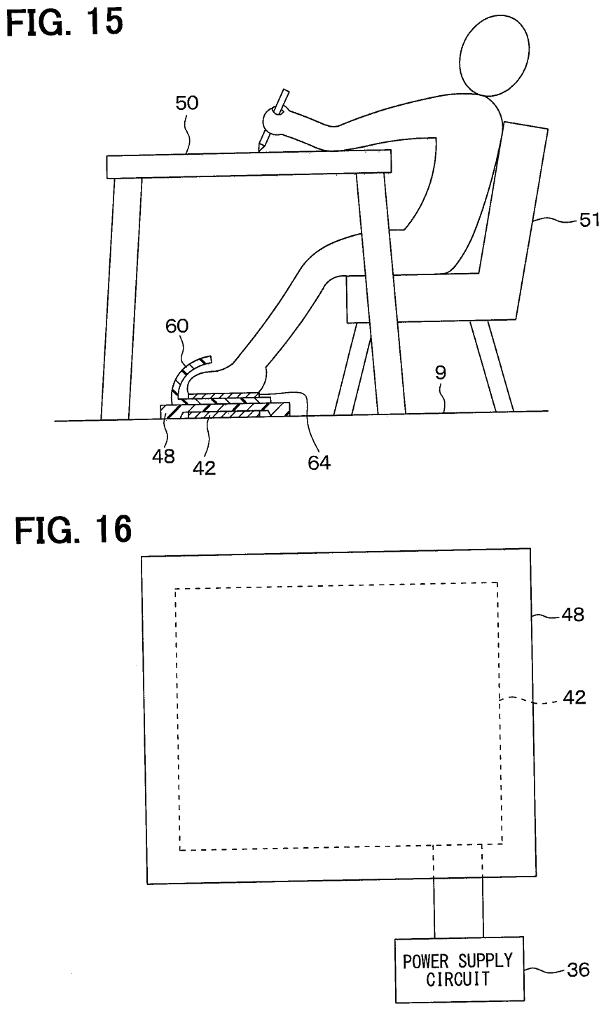

The overall configuration of the heating device according to the third embodiment is shown in FIG. 15. FIG. 15 is a diagram showing a state in which a student sitting on a chair 51 at a cram school and facing towards a learning desk 50 while learning. In FIG. 15, a slipper 60 worn by the student, a floor mat 48, and the like are shown as schematic sectional views. An insole sheet 64 having a metal foil 64b as a heating member is provided on a foot rest surface of the slipper 60 which is a footwear. Here, the insole sheet 64 corresponds to an insole member.

The heating device of the present embodiment has an induction heating coil 42 for electromagnetically heating, in a non-contact manner, the metal foil 64b provided on the insole sheet 64 disposed on the foot rest surface of the slipper 60 worn by the student. The heating device heats the insole sheet 64 by electromagnetic induction using this induction heating coil 42.

As shown in FIG. 16, the induction heating coil 42 and the floor mat 48 are arranged on a floor surface 9 of the building. In the present embodiment, the induction heating coil 42 is disposed at a position where the slipper 60 is located when the student sits on the chair 51 facing toward the learning desk 50. The induction heating coil 42 is formed by forming a conductive metal member in a coil shape. Further, the induction heating coil 42 may be configured to be fixed to the floor surface 9 of the building or may be movable with respect to the floor surface 9 of the building. In addition, the floor mat 48 is disposed on the induction heating coil 42 so as to cover the induction heating coil 42.

A power supply circuit 46 that outputs an AC voltage at a predetermined frequency (for example, 25 kHz) is connected to the induction heating coil 42. When the AC voltage is output from the power supply circuit 46, a current corresponding to the AC voltage flows in the induction heating coil 42.

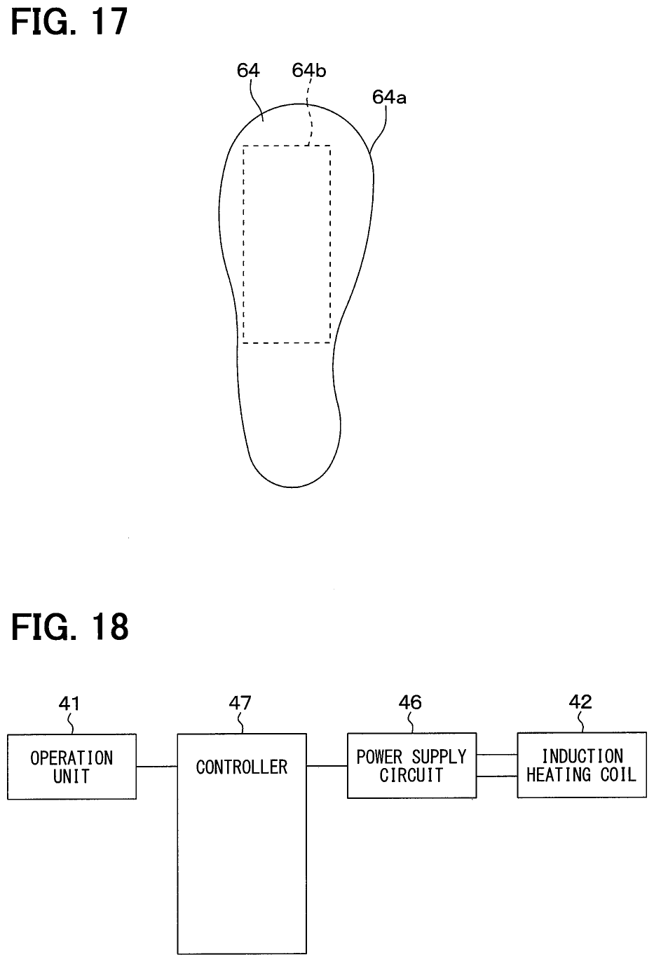

The slipper 60 may be made of, for example, vinyl, rubber or the like, and the insole sheet 64 is provided on the foot rest surface of the slipper 60. FIG. 17 is a view of the insole sheet 64 as viewed from the foot rest surface side. The insole sheet 64 includes, for example, a sheet main body 64a formed by using polyurethane, polyester, or the like, and the metal foil 64b formed using a conductive metal member. The metal foil 64b is bonded and fixed to the surface of the sheet main body 64a opposite from the foot rest surface. The insole sheet 64 is provided separately from the slipper 60.

FIG. 18 is a block configuration diagram of the present heating device. The present heating device includes an operation unit 41, an induction heating coil 42, a power supply circuit 46, and a controller 47.

The operation unit 41 includes a power switch (not shown) for turning on and off the power supply of the heating device, a temperature adjustment switch (not shown) for setting the heating temperature, and the like. The operation unit 41 outputs a signal corresponding to switches operated by the user to the controller 47.

The controller 47 is a computer having a CPU, a ROM, a RAM, I/O, etc., and the CPU performs various arithmetic processing based on programs stored in the ROM to, for example, control the power supply circuit 46.

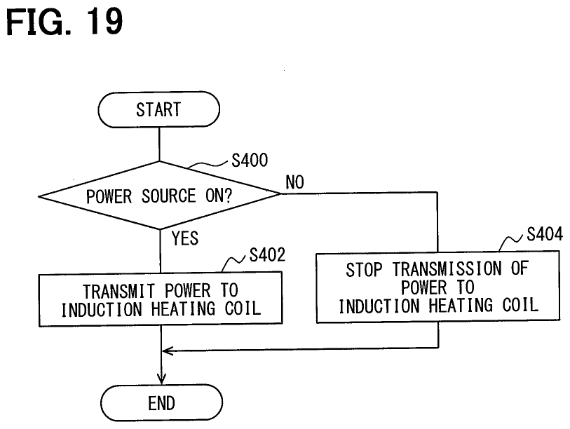

FIG. 19 shows a flowchart of power transmission control by the controller 47 according to the third embodiment. The controller 47 periodically executes the processing shown in FIG. 19.

First, in step S400, the controller 47 determines whether or not to turn on the power supply based on the state of the power switch of the operation unit 41.

Here, when the power switch of the operation unit 41 is on, the controller 47 performs power transmission to the induction heating coil 42 in step S402. Specifically, the power supply circuit 46 is instructed to perform power transmission to the induction heating coil 42.

As a result, when an AC voltage is output from the power supply circuit 46 and an AC current flows through the induction heating coil 22, the magnetic field around the induction heating coil 22 changes. Then, the metal foil 64b of the insole sheet 64 is heated by electromagnetic induction.

Further, when the power switch of the operation unit 41 is turned off, the controller 47 stops power transmission to the induction heating coil 42 in step S404. Specifically, the power supply circuit 46 is instructed to stop power transmission to the induction heating coil 42.

As a result, no AC voltage is output from the power supply circuit 46, no alternating current flows through the induction heating coil 22, and the metal foil 64b of the insole sheet 64 is not heated.

### Other Embodiments

(1) In the first and second embodiments, while power is being supplied to the induction heating coil 22, if it is determined that the impedance of the induction heating coil 22 has become equal to or higher than the reference value Z1 in step S110, the controller 37 proceeds to step S114. Then in step S114, the controller 37 stops the supply of power to the induction heating coil 22. However, alternatively, the controller 37 may instead reduce the electric power supplied to the induction heating coil 22 as compared to prior to determining that the impedance of the induction heating coil 22 has become equal to or higher than the reference value Z1 in step S114. Further alternatively, the controller 37 may instead control the electric power supplied to the induction heating coil 22 to gradually decrease as compared to prior to determining that the impedance of the induction heating coil 22 has become equal to or higher than the reference value Z1.

(2) In the first and second embodiments, the controller 37 stops the output of the power supply circuit 36 in step S116. Alternatively, the controller 37 may reduce the output of the power supply circuit 36 before stopping the output of the power supply circuit 36. Further alternatively, the controller 37 may gradually reduce the output of the power supply circuit 36 before stopping the output of the power supply circuit 36.

(3) In the first and second embodiments, the controller 37 controls the amount of electric power supplied to the induction heating coil 22 based on the impedance Z of the induction heating coil 22. Alternatively, the controller 37 may estimate the temperature of the metal foil 14 from the impedance Z of the induction heating coil 22, and then control the power supplied to the induction heating coil 22 based on the temperature of the metal foil 14 and a predetermined temperature. Specifically, the controller 37 may control the electric power supplied to the induction heating coil 22 so that the temperature of the metal foil 14 is equal to or lower than the predetermined temperature. More specifically, the controller 37 may reduce the amount of power supplied to the induction heating coil 22 or stop the supply power to the induction heating coil 22. Further, when the correlation between the impedance Z of the induction heating coil 22 and the temperature of the metal foil 14 is stored as a map in the ROM, the controller 37 may uses the map stored in the ROM to estimate the temperature of the metal foil 14 based on the impedance Z of the induction heating coil 22.

(4) In the first and second embodiments, the metal foil 14 is formed by a positive temperature characteristic member having PTC characteristics. However, for example, the metal foil 14 may instead be formed by a member whose resistance value changes with temperature change, such as a negative temperature characteristic member which is a resistor having NTC (Negative Temperature Coefficient) characteristics.

(5) In each of the above embodiments, the heating member is formed by the metal foil 14, but the heating member may be provided by a member other than the metal foil such as a wire made of a conductive metal, for example.

(6) In the first and second embodiments, the insole 13 is provided in the shoe of the occupant, but the insole 13 may be provided in footwear such as boots and socks, for example.

(7) In the third embodiment, the insole sheet 64 is provided in the slipper 60, but the slipper 60 is not intended to be limiting. For example, the insole sheet 64 may be provided in footwear such as the shoes of the student.

(8) In the second embodiment, the induction heating coil 22 and the impedance detection circuit 35 are provided in a corresponding manner to the positions of the seats of the vehicle. However, the induction heating coil 22 and the impedance detection circuit 35 are not necessarily provided in a corresponding manner to the positions of the seats of the vehicle.

(9) In the first embodiment, the induction heating coil 22 and the impedance detection circuit 35 are provided on the foot rest surface of the accelerator pedal 5 of the vehicle. However, the induction heating coil 22 and the impedance detection circuit 35 may be provided in different places instead.

(10) In the second embodiment, the controller 37 controls power supplied to the induction heating coil 22 based on the impedance of the induction heating coil 22 detected by the impedance detection circuit 35. However, the controller 37 may instead individually detect the impedances of the plurality of induction heating coils 22 by a plurality of impedance detection circuits 35. Further alternatively, the controller 37 may instead individually detect the impedances of the plurality of induction heating coils 22 by using a plurality of impedance detection circuits 35, and individually control the electric power to be supplied to the plurality of induction heating coils 22.

(11) In the third embodiment, the induction heating coil 22 is arranged on the floor surface 9 of the building of the cram school, but the induction heating coil 22 is not limited to being used in a cram school, and the induction heating coil may be disposed on the floor surface of various buildings such as study class or a movie theater.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

### Conclusion

According to a first aspect represented by a portion or all of the above embodiments, a heating device includes an insole member which is disposed in a footwear and which includes a heating member, an induction heating coil that heats the heating member through electromagnetic induction, where the insole member is formed separately from the footwear.

According to a second aspect, the induction heating coil is installed in the vehicle interior of a vehicle. Due to the above, it is possible to heat the heating member provided in the footwear of the occupant of the vehicle.

According to a third aspect, the induction heating coil is installed on the floor surface of a building. Due to the above, it is possible to heat the heating member provided in the footwear of the user in the building.

According to the fourth aspect, a controller 37 includes an impedance detection circuit that detects the impedance of the induction heating coil which is correlated with the temperature of the heating member. Then, a power control unit controls the power supplied to the induction heating coil based on the impedance of the induction heating coil detected by the impedance detection circuit.

The apparatus described in Patent Document 1 is configured to detect the temperature of the heating member by bringing a temperature sensor provided in the heating device into contact with a temperature detection portion provided at the bottom of the ski tool. For this reason, for example, if an object having a low thermal conductivity such as a stone is interposed between the temperature sensor and the temperature detection portion, the temperature of the heating unit may not be accurately detected. In this regard, if the temperature of the heating unit is not accurately detected, the power control of the heating unit may not be performed with high accuracy.

However, according to the fourth aspect, since the power control unit controls the power to be supplied to the induction heating coil based on the impedance of the induction heating coil detected by the impedance detection circuit, it is possible to more accurately control the heating of the heating member.

According to a fifth aspect, the power control unit estimates the temperature of the heating member based on the impedance of the induction heating coil detected by the impedance detection circuit. Then, when the temperature of the heating member becomes equal to or higher than a predetermined temperature, the power control unit controls the power supplied to the induction heating coil so that the temperature of the heating member becomes lower than the predetermined temperature.

According to a sixth aspect, the heating device includes a plurality of induction heating coils, and the power control unit controls electric power supplied to the plurality of induction heating coils. In this manner, it is possible to control the power supplied to the plurality of induction heating coils with one power control unit.

According to a seventh aspect, the power control unit supplies a predetermined amount of electric power to the induction heating coil when the ignition switch of the vehicle turns from off to on.

According to an eighth aspect, the heating device includes an outside air temperature sensor that detects the outside air temperature. The power control unit supplies a predetermined amount of electric power to the induction heating coil when the outside air temperature detected by the outside air temperature sensor is equal to or lower than a reference outside air temperature. Due to this, when the outside air temperature is equal to or lower than the reference outside air temperature, a predetermined amount of electric power is supplied to the induction heating coil 22, so that the heating member can be quickly heated.

According to a ninth aspect, the heating device includes a cooling water temperature sensor that detects the temperature of the engine cooling water of the vehicle. The power control unit supplies a predetermined amount of electric power to the induction heating coil when the temperature of the engine cooling water of the vehicle detected by the cooling water temperature sensor is equal to or lower than a reference water temperature.

When the temperature of the engine cooling water of the vehicle is low, hot air is not blown out from the foot air outlet of the air conditioner for the vehicle, but when the temperature of the engine cooling water of the vehicle is lower than the reference water temperature, a predetermined amount of electric power is supplied to the induction heating coil, so that the heating member can be quickly heated.

According to a tenth aspect, the heating device is provided with a mode sensor that detects whether the blowing mode of the vehicle air conditioner is one of the foot mode or the foot defroster mode. Then, when the mode sensor detects that the blowing mode is one of the foot mode or the foot defroster mode, the power control unit supplies a predetermined amount of electric power to the induction heating coil.

The foot mode and the foot defroster mode are typically blowing modes set during heating. In this regard, when the foot mode or the foot defroster mode is set as the blowing mode, a predetermined amount of electric power is supplied to the induction heating coil, so that the heating member can be quickly heated.

According to an eleventh aspect, when a predetermined amount of time has elapsed since starting the power supply to the induction heating coil, the heating device reduces the power supplied to the induction heating coil as compared to before the elapse of the predetermined amount of time.

In this regard, when a predetermined amount of time has elapsed since starting the power supply to the induction heating coil, the power supplied to the induction heating coil may be reduced as compared to before the elapse of the predetermined amount of time. Therefore, power consumption can be reduced.

According to a twelfth aspect, the heating device includes an occupant sensor that detects whether or not an occupant is present in each seat of the vehicle, and induction heating coils are provided at a plurality of positions corresponding to the positions of the seats.

Then, when the occupant sensor detects that an occupant is present, the power control unit supplies a predetermined amount of electric power to the induction heating coils provided corresponding to the positions of the seats where occupants are present, and stops the supply of electric power to the induction heating coils provided corresponding to the positions of the seats where no occupant is present.

As a result, the power supply to the induction heating coils provided corresponding to the positions of the seats where there is no occupant is reduced. Therefore, unnecessary power consumption is suppressed.

According to a thirteenth aspect, the heating member is made of a PTC characteristic material whose resistance value increases as the temperature rises.

Due to this, when the temperature rises and reaches a predetermined temperature (that is, the Curie point), the impedance Z of the induction heating coil also begins to change significantly. Accordingly, power transmission control of the induction heating coil can be performed with high accuracy.

According to a fourteenth aspect, the power control unit controls the power supplied to the induction heating coil so that the temperature of the heating member gradually decreases as compared to before the predetermined amount of time elapsed.

According to a fifteenth aspect, the induction heating coil is provided on at least one of an accelerator pedal, a brake pedal, a footrest, or a floor mat of the vehicle.

What is claimed is:

1. A heating device, comprising:
an insole member which is disposed in a footwear and which includes a heating member; and
an induction heating coil that heats the heating member through electromagnetic induction, wherein
the insole member is formed separately from the footwear,
the insole member includes a surface that contacts a sole of a user, and
the heating member is disposed on the surface of the insole member.

2. The heating device according to claim 1, wherein the induction heating coil is provided in a passenger compartment of a vehicle.

3. The heating device according to claim 1, wherein the induction heating coil is provided on a floor surface of a building.

4. The heating device according to claim 1, further comprising:
an impedance detection circuit that detects an impedance of the induction heating coil which is correlated with a temperature of the heating member, wherein
a power control unit controls an electric power supplied to the induction heating coil based on the impedance of the induction heating coil detected by the impedance detection circuit.

5. The heating device according to claim 4, wherein
the power control unit estimates a temperature of the heating member based on an impedance of the induction heating coil detected by the impedance detection circuit, and when the temperature of the heating member is equal to or above a predetermined temperature, the power control unit controls an electric power supplied to the induction heating coil such that the temperature of the heating member becomes lower than the predetermined temperature.

6. The heating device according to claim 1, further comprising:
a plurality of the induction heating coil, wherein
a power control unit controls electric power supplied to the plurality of induction heating coils.

7. The heating device according to claim 1, wherein a power control unit supplies a predetermined amount of electric power to the induction heating coil when an ignition switch of a vehicle is turned from off to on.

8. The heating device according to claim 1, further comprising:
an outside air temperature sensor that detects an outside air temperature, wherein
a power control unit supplies a predetermined amount of electric power to the induction heating coil when the outside air temperature detected by the outside air temperature sensor is equal to or lower than a reference outside air temperature.

9. The heating device according to claim 1, further comprising:
a cooling water temperature sensor that detects a temperature of an engine cooling water of a vehicle, wherein
a power control unit supplies a predetermined amount of electric power to the induction heating coil when the temperature of the engine cooling water of the vehicle detected by the cooling water temperature sensor is equal to or lower than a reference water temperature.

10. The heating device according to claim 1, further comprising:
a mode sensor that detects whether a blowing mode of a vehicle air conditioner is one of a foot mode or a foot defroster mode, wherein
a power control unit supplies a predetermined amount of electric power to the induction heating coil when the mode sensor detects that the blowing mode is one of the foot mode or the foot defroster mode.

11. The heating device according to claim 1, wherein when a predetermined amount of time has elapsed since starting power supply to the induction heating coil, the electric power supplied to the induction heating coil is reduced as compared to before the predetermined amount of time elapsed.

12. The heating device according to claim 1, further comprising:
an occupant sensor that detects whether or an occupant is present in seats of a vehicle, wherein
a plurality of the induction heating coil are provided positions corresponding to positions of the seats, and
when the occupant sensor detects that an occupant is present, the power control unit supplies a predetermined amount of electric power to the induction heating coils provided corresponding to the positions of the seats where an occupants is present, and stops the supply of electric power to the induction heating coils provided corresponding to the positions of the seats where no occupant is present.

13. The heating device according to claim 1, wherein the heating member is made of a PTC characteristic material whose resistance value increases as temperature increases.

14. The heating device according to claim 11, wherein a power control unit controls electric power supplied to the induction heating coil such that a temperature of the heating member gradually decreases as compared to before the predetermined amount of time elapsed.

15. The heating device according to claim 1, wherein the induction heating coil is provided in at least one of an accelerator pedal, a brake pedal, a footrest, or a floor mat of a vehicle.
